(19) United States
(12) Patent Application Publication
(10) Pub. No.: US 2025/0343361 A1
(43) Pub. Date: Nov. 6, 2025

(54) PCB-BASED METASURFACE APERTURE ANTENNA

(71) Applicant: Kymeta Corporation, Redmond, WA (US)

(72) Inventors: Mohammad Ranjbarnikkhah, Redmond, WA (US); Mohammad Mahdi Honari Kalateh, Redmond, WA (US); Seyed Mohamad Amin Momeni Hasan Abadi, Redmond, WA (US); Mohsen Sazegar, Redmond, WA (US); Tyler McSorley, Redmond, WA (US)

(21) Appl. No.: 19/195,252

(22) Filed: Apr. 30, 2025

Related U.S. Application Data
(60) Provisional application No. 63/641,866, filed on May 2, 2024.

(51) Int. Cl. H01Q 19/00; H01Q 1/52; H01Q 9/04

(52) U.S. Cl. CPC H01Q 19/005; H01Q 1/521; H01Q 9/0414; H01Q 9/0442

(57) ABSTRACT

An antenna having a plurality of RF radiating antenna elements (e.g., resonators) that include a double layer iris and methods of using the same are disclosed. In some embodiments, an antenna has a metasurface having a plurality of RF radiating antenna elements, where each of the RF antenna elements has a double layer iris with a first metal layer having a first iris and a second metal layer having a second iris in which first and second irises form a vertical stack in which the first iris is over the second iris.

### RELATED APPLICATION

The present application is a non-provisional application of and claims the benefit of U.S. Provisional Patent Application No. 63/641,866, filed May 2, 2024, and entitled “METASURFACE APERTURE ANTENNA”, which is incorporated by reference in its entirety.

### FIELD OF THE DISCLOSURE

Embodiments of the present disclosure are related to wireless communication; more particularly, embodiments disclosed herein related to an antenna having a plurality of RF radiating antenna elements that include a double layer iris.

### BACKGROUND

Metasurface antennas have recently emerged as another example of an electronically steerable antenna for generating steered, directive beams from a lightweight, low-cost, and planar physical platform. Such metasurface antennas have been recently used in a number of applications, such as, for example, satellite communication.

Metasurface antennas may comprise metamaterial antenna elements that can selectively couple energy from a feed wave to produce beams that may be controlled for use in communication. These antennas are capable of achieving comparable performance to phased array antennas from an inexpensive and easy-to-manufacture hardware platform.

### SUMMARY

An antenna having a plurality of RF radiating antenna elements (e.g., resonators) that include a double layer iris and methods of using the same are disclosed. In some embodiments, an antenna has a metasurface having a plurality of RF radiating antenna elements, where each of the plurality of RF antenna elements comprises a double layer iris with a first metal layer having a first iris and a second metal layer having a second iris in which first and second irises form a vertical stack in which the first iris is over the second iris.

In some other embodiments, the antenna includes a metasurface structure having a plurality of RF radiating antenna elements. Each of the RF antenna elements includes at least one tunable iris formed in a first metal layer, at least one substrate layer coupled to a first side of the first metal layer, a superstrate coupled to a second side of the first metal layer, and a tuning element coupled to the first metal layer through the superstrate.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded view of some embodiments of a flat-panel antenna.

FIG. 2 illustrates an example of a communication system that includes one or more antennas according to some embodiments.

FIG. 3 illustrates some embodiments of a double layer iris radiator.

FIG. 4 illustrates some other embodiments of a double layer iris radiator.

FIG. 5 illustrates some embodiments of a small portion of a shared aperture.

FIG. 6 illustrates a full-size wedge simulation comparison of printed circuit boards (PCBs) with radial placement for two cases of two-via and six-via double layer iris radiator.

FIG. 7 illustrates a full-size wedge simulation comparison of PCB with radial placement versus a reference glass design.

FIG. 8 is a side view of some embodiments of a two-via double layer stacked iris resonator.

FIG. 9 is a graph of radiation efficiency versus the frequency for a PCB substrate having no routing lines and a PCB substrate having routing lines.

FIGS. 10A-10B illustrate some embodiments of a double layer iris radiator that includes structures for compensating the capacitance.

FIGS. 11A-11C illustrate some embodiments of a double layer iris radiator with different capacitance through the use of a middle layer of the PCB.

FIG. 12 illustrates a portion of some embodiments of an antenna aperture that includes a structure between RF radiating antenna elements (e.g., adjacent double layer iris resonators) for mutual coupling reduction.

FIGS. 13A and 13B illustrate the use of an electromagnetic bandgap (EBG) structure in a metasurface antenna to suppress a surface wave.

FIGS. 14A-14B illustrate top and side views of some embodiments of an iris-based RF radiating antenna element in a metasurface structure.

FIG. 15 illustrates two adjacent radiating antenna elements (e.g., resonators).

FIG. 16 illustrates different mutual coupling levels for different scenarios for the antenna elements in FIG. 15.

FIG. 17 is a plot of the mutual coupling amplitude between adjacent elements for metasurface antenna in FIG. 15.

FIGS. 18A and 18B illustrate some embodiments of a metasurface antenna with

integrated superstrate.

FIG. 19 illustrates receive (Rx) and transmit (Tx) elements of the metasurface antenna with a superstrate.

FIG. 20 illustrates the radiation efficiency of some embodiments of an antenna with superstrate is far better than the antenna without superstrate over both Rx band (10.7-12.7 GHz) and Tx band (13.75-14.5 GHz).

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

One of the key challenges in the design of large metasurface phased arrays is the effective control of electromagnetic energy leakage between adjacent cells. This leakage can significantly degrade the performance and efficiency of the system. Some embodiments disclosed herein address this challenge by strategically placing only two vias in the middle of each slot of a radio-frequency (RF) radiating antenna element within a metasurface-PCB (printed circuit board). These carefully positioned vias play a crucial role in reducing the undesired leakage of electromagnetic energy. By locating the vias at this specific position, the coupling between adjacent cells is reduced, and in some cases effectively minimized, resulting in improved isolation and enhanced performance of the metasurface phased array.

In some embodiments, the metasurface includes structures for reducing the mutual coupling between RF radiating antenna elements (e.g., resonators, etc.). In some embodiments, an electromagnetic bandgap (EBG) structure is used between RF radiating antenna elements (e.g., resonators) to suppress a surface wave resulting in mutual coupling reduction. In this metasurface structure, the EBG geometries are added between metasurface elements within the substrate (e.g., PCB) of the metasurface. In some other embodiments, a component of electromagnetic mode is added to the primary mutual coupling mode so that the superposition of these two would have lower amplitude compared to the primary mode. In some embodiments, the proposed structure consists of two iris metal layers (i.e., metal layers in which irises are formed) and connecting vias that connect the top and bottom iris metal layers.

In some embodiments, the metasurface includes a superstrate for increasing the radiation efficiency of metasurface elements. In some embodiments, the superstrate is on top of the tunable antenna element (e.g., resonator) with a tuning element (e.g., a varactor) on top of the superstrate over the tunable antenna element (e.g., resonator).

Other embodiments disclosed herein include PCB-based metasurface aperture antennas.

### Examples of Antenna Embodiments

The techniques described herein may be used with a variety of flat panel satellite antennas. Embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Patent Application Publication No. 20210050671, entitled “Metasurface Antennas Manufactured with Mass Transfer Technologies,” published Feb. 18, 2021. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

In some embodiments, the antenna aperture having the one or more arrays of antenna elements is comprised of multiple segments that are coupled together. In some embodiments, when coupled together, the combination of the segments form groups of antenna elements (e.g., closed concentric rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

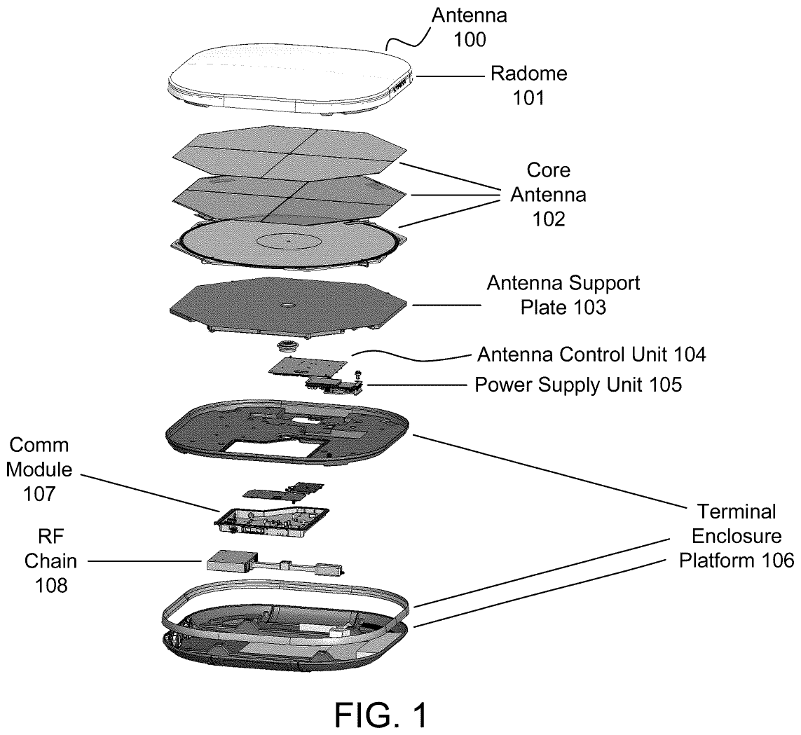

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Patent Application Publication No. 20210050671, entitled “Metasurface Antennas Manufactured with Mass Transfer Technologies,” published Feb. 18, 2021. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

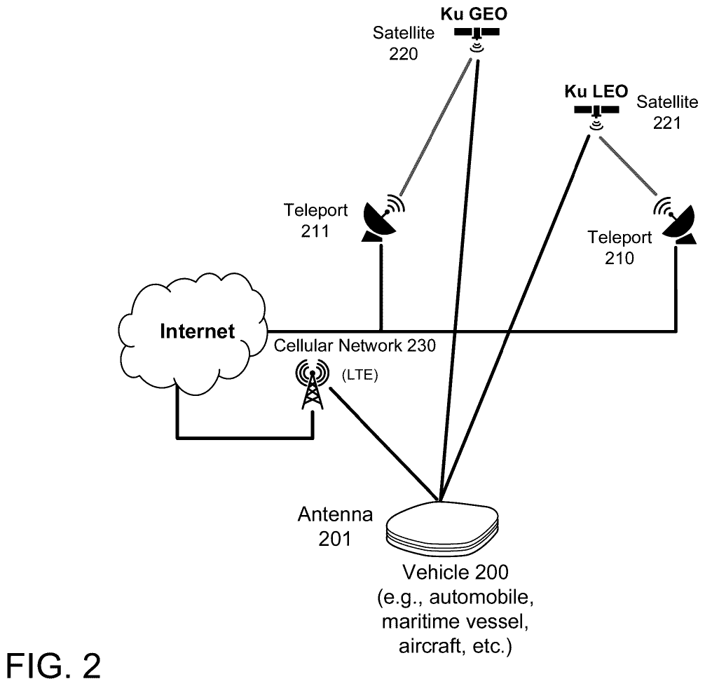

FIG. 2 illustrates an example of a communication system that includes one or more antennas described herein. Referring to FIG. 2, vehicle 200 includes an antenna 201. In some embodiments, antenna 201 comprises antenna 100 of FIG. 1. In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause, or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communication with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. patent Ser. No. 16/750,439, entitled “Multiple Aspects of Communication in a Diverse Communication Network”, and filed Jan. 23, 2020.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221. Thus, the antennas described herein may be part of a satellite terminal that enables ubiquitous communications and multiple different communication connections.

### PCB-Based Metasurface Aperture Antenna Terminal

Embodiments disclosed herein include innovative implementations that leverages printed circuit board (PCB) technology to create a high performance metasurface antenna. By utilizing newer PCB technology such as high-density interconnect (HDI) subtractive and/or semi-additive processes, the implementation of a high-precision double layer iris radiator (e.g., with one iris at a top layer vertically above another iris at a bottom layer) element and strategically placed vias enable the creation of a consistent and reliable shielding structure for shielding RF elements/unit cells across a metasurface. These newer PCB technologies can create extremely thin multi-layer PCB stacks, less than 20 mil for 6-layers, which enable the metasurface feed coupling performance. Placing a tunable capacitor die on the RF element is possible with new placement technology that has been designed for use with this type of PCB, completing the assembly process of this novel metasurface antenna. The low development cost and ease of fabrication associated with PCB technology make it feasible to rapidly prototype and integrate the proposed solution into large-scale applications.

Some embodiments described herein leverage the advantages of new PCB technologies that enable novel designs to metasurface antennas. The double layer iris and surrounding vias, which act as a shield for RF elements and prevent energy coupling with routing traces, can be precisely and consistently produced using HDI subtractive and/or semi-additive PCB processes.

By utilizing PCB technology, the implementation of a double layer iris (e.g., with one iris at a top layer vertically above another iris at a bottom layer) and surrounding vias becomes more efficient and cost-effective. PCB manufacturing processes allow for precise and repeatable production of intricate patterns on very small scales, such as the double layer iris and the strategically placed vias. This enables the creation of a consistent and reliable shielding structure for the RF elements, ensuring uniform performance across the metasurface unit cells that is not possible with other metasurface antenna platforms.

In some embodiments, low cost is accomplished using an “Any-layer” PCB process that can be a part of HDI subtractive and/or semi-additive PCB fabrication methods. The “Any- layer” process allows the double-walled iris layers of the PCB stack to be manufactured to higher tolerance standards, with the middle routing layers being held to lower-tolerance standards. The higher and lower tolerance layers are then mated together to create the PCB metasurface antenna. This creates a PCB stack that is low cost due to only 2 of the layers being held to high tolerance standards.

The low cost of PCB technology makes it feasible to integrate its use into large-scale applications. That is, the affordability of PCB technology facilitates the incorporation of the double layer iris and vias into arrays comprising numerous metasurface unit cells. This scalability opens up possibilities for advanced beam steering capabilities on a broader scale, offering enhanced performance and versatility.

Furthermore, the ease of fabrication associated with PCB technology allows for rapid prototyping and iterative design improvements. Designers can efficiently experiment with different configurations, optimizing the placement and characteristics of the double layer iris and vias to achieve desired shielding and beam steering performance. This iterative approach saves time and resources during the development process, ultimately leading to a more refined and effective solution.

In summary, the use of PCB technology in some embodiments described herein offers different advantages. It not only ensures low-cost and easy fabrication of the double layer iris and surrounding vias but also enables scalability and rapid prototyping. Leveraging these benefits, the disclosed techniques become more accessible, versatile, and efficient, enhancing beam steering capabilities while mitigating electromagnetic interference.

Also, some embodiments employ strategic placement of only two vias in the middle of each slot within the metasurface-PCB to reduce, and potentially minimize, the undesired coupling. By carefully locating these vias, leakage is effectively reduced, improving isolation and overall performance. The simplicity and low-cost structure of the designs disclosed herein make large-scale metasurface phased arrays more accessible and affordable. Techniques disclosed herein enable the creation of high-resolution, cost-effective arrays while maintaining excellent performance.

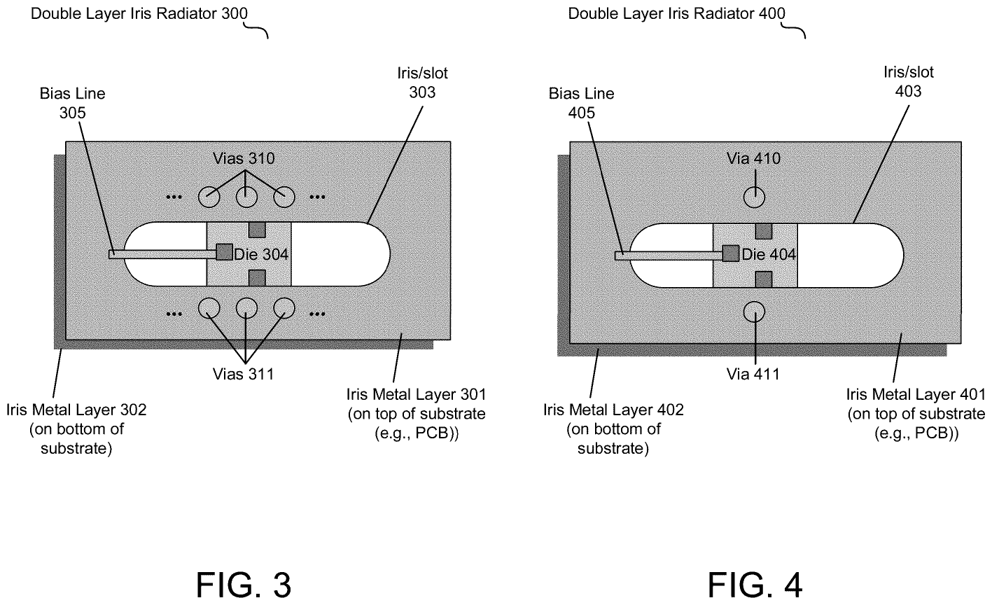

FIG. 3 illustrates some embodiments of a radiator element comprising two vertically stacked slots (e.g., one slot at the top of a substrate (e.g., a PCB) over one slot at the bottom of the substrate to form a vertical stack), with the die positioned on the upper slot. Referring to FIG. 3, a double layer iris radiator 300 includes iris metal layer 301 (on top of a substrate (e.g., PCB)) and iris metal layer 302 (on the bottom of the substrate). Note that this substrate has not been shown to avoid obscuring the teachings herein. Each of iris metal layers 301 and 302 include an iris (slot). For example, iris 303 is formed in iris metal layer 301, and an iris (not shown) is also formed in iris metal layer 302. Iris metal layers 301 and 302 are stacked in a vertical position with the irises formed within those layers are vertically stacked (aligned) with each other. Double layer iris radiator 300 also includes die 304 coupled across iris 303. In some embodiments, die 304 includes a tuning element, such as, for example, a varactor or other tuning element. Die 304 can also include a capacitor (e.g., fixed capacitor, MIM, etc.) and/or an amplifier. A bias line 305 is coupled to die 304 to provide a voltage to the tuning element (e.g., a voltage to the varactor).

Double layer iris radiator 300 also includes a series vias 310 and 311 along the elongated portions of the slot 303. In some embodiments, the vias extend through the substrate from iris metal layer 301 to iris metal layer 302. In other words, the vias extend through the substrate from the slot at the top of the substrate to the slot in the vertical stack at the bottom of the substrate. In some embodiments, the series of vias encircle the stacked irises (slots). As shown, vias 310 and 311 are each three in number, thereby totaling six vias. However, vias 310 and 311 may include only a single via on each side or a plurality of vias other than 3 (e.g., 2, 4, 5, 6, etc.). The number of vias on each side does not have to be the same in number. Where multiple vias are on a side, these vias could form a via wall. If vias are placed around a slot partially or fully, such via walls would form a via cage. The spacing between vias in a via wall or a via cage can be small compared to the wavelength. In some embodiments, the spacing between such vias can be wavelength λ/10. While the top of the vias appear round in FIG. 3 and shaped as cylinders, the techniques disclosed herein are not limited to having vias shaped in this matter. The vias can be shaped in variety of shapes. For example, the vias could be square-shaped, rectangularly-shaped, oval-shaped, or any other shape (as opposed to circular) when viewed from the top. The radius, or thickness, of a via when viewed from the top is much smaller than the wavelength λ.

In some embodiments, an RF radiating antenna element includes two vias strategically positioned in the middle portion of the elongated sides of each slot. These vias play a crucial role in reducing, and potentially minimizing, undesired leakage of electromagnetic energy between adjacent cells. That is, by placing the vias in specific locations, the leakage between cells is effectively reduced, which is a critical challenge in metasurface-PCB designs. In some embodiments, the placement of the vias is centrally located along the elongated portion of the slot where the electric field is the strongest. The reduction in leakage ensures enhanced performance and efficiency of the overall system. This innovation contributes to the advancement of metasurface technologies, enabling better control and manipulation of electromagnetic waves for various applications, including communication systems, antenna designs, and sensing devices.

One of the significant advantages of this approach lies in its simplicity and cost-effectiveness. By using only two vias per cell, the design eliminates the need for complex and expensive manufacturing processes, thereby making large-scale metasurface phased arrays more accessible and affordable. The low-cost structure of the metasurface-PCB, combined with the strategic via placement, enables the creation of large-scale phased arrays with ease. The simplicity of the design not only reduces the manufacturing costs but also allows for scalability. It becomes feasible to fabricate metasurface phased arrays with a large number of cells, enabling high-resolution beamforming and precise control of electromagnetic waves.

Moreover, the use of a low-cost structure does not compromise the performance of the metasurface phased array. In fact, research demonstrates that the strategic via placement enhances the overall system performance by reducing, and potentially minimizing, the leakage and improving the isolation between cells. In summary, the disclosed innovative approach in some embodiments of strategically placing two vias in the middle portion of the elongated sides of each slot within the metasurface-PCB offers a simple, cost-effective solution for large-scale metasurface phased arrays. This breakthrough enables improved control over electromagnetic waves, paving the way for advanced communication systems, while maintaining affordability and scalability.

When electromagnetic waves propagate through the metasurface-PCB, the electric field distribution is influenced by the geometry and configuration of the structure. In the case of the stacked slots, the electric field tends to concentrate and be most intense in the middle region of the slot. This concentration of the electric field is a result of the specific design and arrangement of the slots of RF radiating antenna elements within the metasurface-PCB. By placing two vias in the middle of the stacked slots, these vias intercept and interact with the concentrated electric field. The vias serve as effective pathways for the transmission of the electric field, guiding it through the desired channels while minimizing leakage. This strategic placement improves, and potentially optimizes, the coupling between the slots and allows for efficient control and manipulation of the electric field within the metasurface structure. Therefore, based on the physics involved, the electric field is indeed focused in the middle of the slot, and the placement of two vias at this location proves to be sufficient for reducing leakage and enhancing the performance of the metasurface-PCB.

In some embodiments, the radiator element consists of two-via stacked slots, with the die placed on the top slot. FIG. 4 illustrates some embodiments of a double layer iris radiator with stacked slots and a via on each side of the stacked slots. Referring to FIG. 4, double layer iris radiator 400 includes only a single via along a middle portion of the elongated sides of the iris shown as vias 410 and 411. Double layer iris radiator 400 includes iris metal layer 401 (on top of a substrate (e.g., PCB)) and iris metal layer 402 (on the bottom of the substrate). Note that this substrate has not been shown to avoid obscuring the teachings herein. Each of iris metal layers 401 and 402 include an iris (slot). For example, iris slot 403 is formed in iris metal 401, and an iris (not shown) is also formed in iris metal layer 402. Iris metal layers 401 and 402 are stacked in a vertical position with the irises vertically stacked (aligned) with each other. Double layer iris radiator 400 also includes die 404 coupled across iris 403. In some embodiments, die 404 includes a tuning element, such as, for example, a varactor or other tuning element. Die 404 can also include a capacitor (e.g., fixed capacitor, MIM, etc.) and/or an amplifier. A bias line 405 is coupled to die 404 to provide a voltage to the tuning element (e.g., a voltage to the varactor). Double layer iris radiator 400 also includes vias 410 and 411 on both of the elongated sides of the iris 403. The vias extend from iris metal layer 401 to iris metal layer 402.

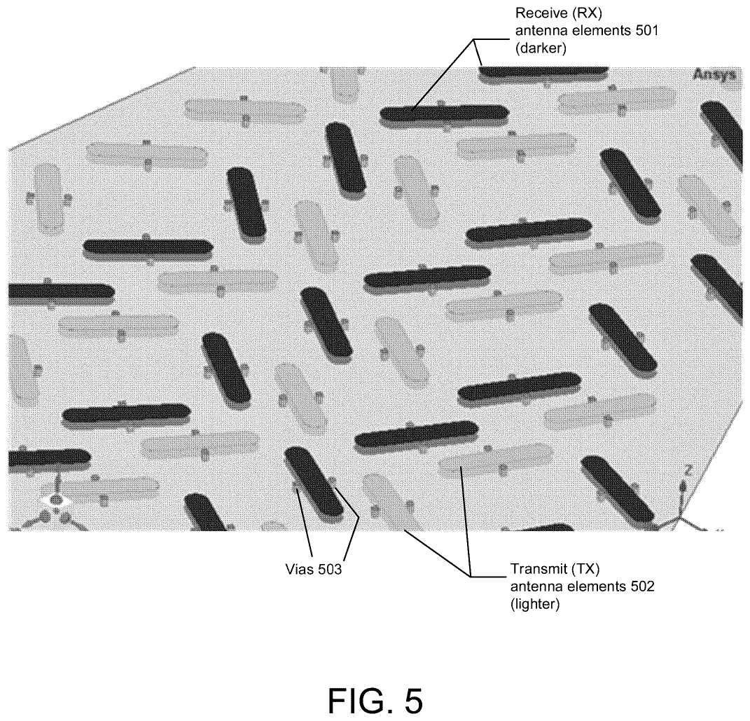

FIG. 5 illustrates a full size 30 deg wedge shared aperture based on the two-via concept of having one via on each elongated side of an iris. Referring to FIG. 5, receive (RX) antenna elements 501 (darker) and transmit (TX) antenna elements 502 (lighter) are shown as part of an aperture. As shown, the antenna elements 501 and 502 are irises with a via on each elongated side of the iris, such as, for example, vias 503 that are on the elongated sides of a receive antenna element. Note that although only one via is shown on each side of the antenna elements 501 and 502 in FIG. 5, the number of vias may be greater than 1, such as, for example, 2, 3, 4, etc.

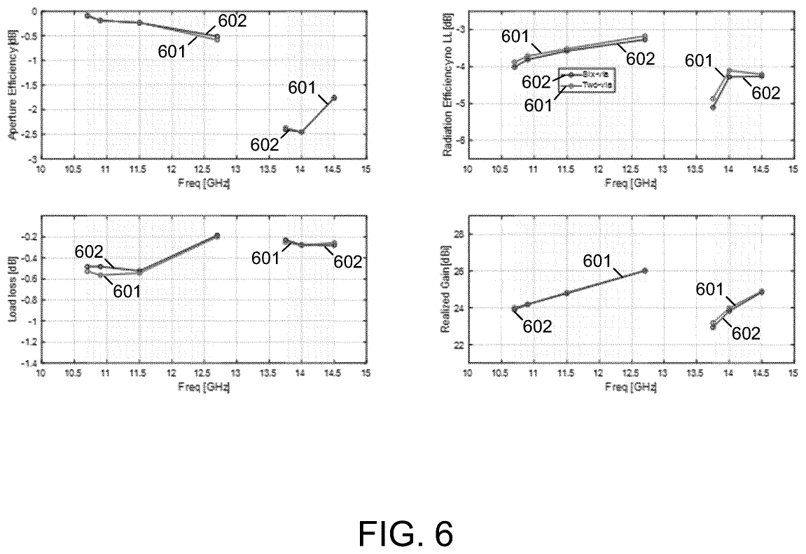

FIG. 6 illustrates a full size 30 deg wedge simulation comparison of PCB with radial placement for two cases of two-via and six-via. Referring to FIG. 6, four graphs are displayed representing the aperture efficiency versus the frequency, the radiation efficiency versus the frequency, the load loss versus the frequency, and the realized gain versus the frequency for the double layer iris radiator having two vias (one via on each side of the iris) or six vias (three vias on each side of the iris). As shown in each graph, the performance for both the two-via implementation (601) and six-via implementation (602) of the double layer iris radiator are very comparable with each other. Thus, while either implementation provides substantially similar benefits, this also shows that a two-via can be useful on PCB implementation (e.g., a 10 mil PCB board).

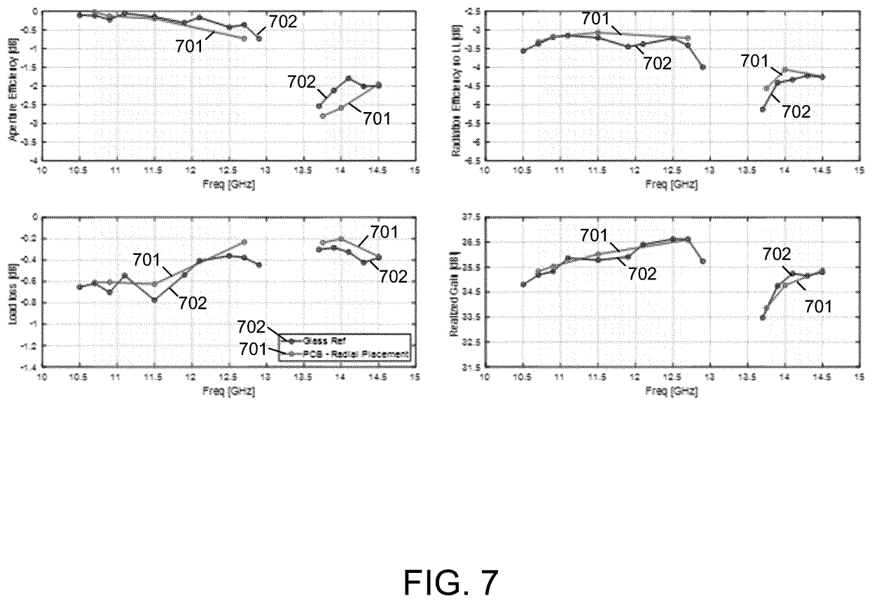

FIG. 7 illustrates a full size 30 deg wedge simulation comparison of PCB with radial placement vs reference glass design. A low-loss PCB material (EM-526, LT<0.01) with a total thickness of 0.01 is used in this design while focusing on iris size design in PCB technology. The goal is to try to achieve the possible bound and very close to a glass reference design (glass design). Referring to FIG. 7, four graphs are displayed representing the aperture efficiency versus the frequency, the radiation efficiency versus the frequency, the load loss versus the frequency, and the realized gain versus the frequency for the PCB based double layer iris radiator versus a double layer iris radiator implemented glass reference design. As shown in the four graphs of FIG. 7, achieved performance of the PCB (701) was on par with the glass reference design (702).

In terms of cost benefits, utilizing only two vias per cell significantly simplifies the design and manufacturing process of the metasurface-PCB. Compared to more complex designs requiring multiple vias or intricate manufacturing techniques, this approach offers a cost-effective solution. The reduction in manufacturing complexity leads to lower production costs, making large-scale metasurface phased arrays more economically viable.

### Routing Effect

Furthermore, the simplicity of the via placement facilitates the suppression of routing line effects. When routing lines are present between the array RF radiating antenna elements, the strategic placement of the vias mitigates the undesired coupling and interference caused by these lines. In summary, the stacked configuration of two slots with a via placed between them in the middle provides physical advantages in reducing leakage between RF radiating elements (e.g., double layer iris radiators, etc.) in large arrays. This arrangement improves isolation, ensures balance, and simplifies design and manufacturing. Additionally, these vias help suppress the effects of routing lines, contributing to enhanced performance and reliability in metasurface phased arrays.

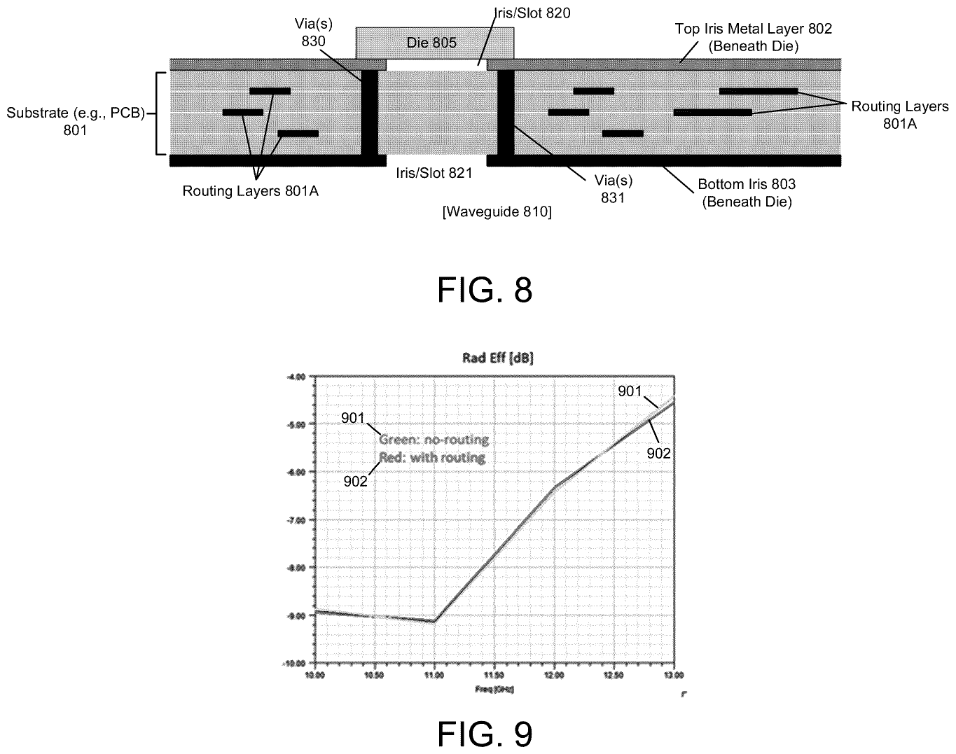

FIG. 8 is a side view of some embodiments of a two-via double layer stacked iris resonator, such as shown in FIG. 4. Referring to FIG. 8, an iris (slot) 820 is formed in top iris metal layer 802 and iris (slot) 821 is formed in bottom metal layer 803 and together form a vertically-stacked iris. In some embodiments, the top metal layer 802 and bottom metal layer 803 comprise copper, but can be made of other conductive materials and metals. Between top metal layer 802 and bottom layer 803 is substrate 801. In some embodiments, substrate 801 comprises of PCB. Substrate 801 includes routing layers 801A throughout for routing such as, for example, signals to control the double layer iris radiator 400. The vertically-stacked irises 820 and 821 and the bottom metal layer 803 are over waveguide 810.

Via(s) 830 and via(s) 831 extend between top metal layer 802 and bottom metal layer 803. In some embodiments, via(s) 830 and via(s) 831 are each only a single via, while in some other embodiments, each represents multiple vias. In some embodiments, via(s) 830 and via(s) 831 electrically connect top metal layer 802 and bottom metal layer 803. Double layer stacked iris radiator 400 also includes die 805 coupled across iris (slot) 820. In some embodiments, die 805 includes a tuning element, such as, for example, a varactor or other tuning element. Die 805 can also include a capacitor (e.g., fixed capacitor, MIM, etc.) and/or an amplifier.

FIG. 9 is a graph of the radiation efficiency versus the frequency for when the PCB substrates has no routing lines (901) and when the PCB substrate has routing lines (902). As shown in FIG. 9, routing lines will not affect performance for a two-via stacked iris resonator. Even when the routing lines are added, the same radiation efficiency is observed from the cell (resonator) design.

### Engineering the Middle Layers

This section discloses an electronics design methodology for engineering the middle layer of PCB-metasurfaces. By employing a double layer iris in conjunction with surrounding vias, this technique effectively shields RF radiating antenna elements, ensuring the elimination of energy coupling with routing traces. The precision and consistency with which these features can be produced using standard PCB processes exemplify the nature of this approach.

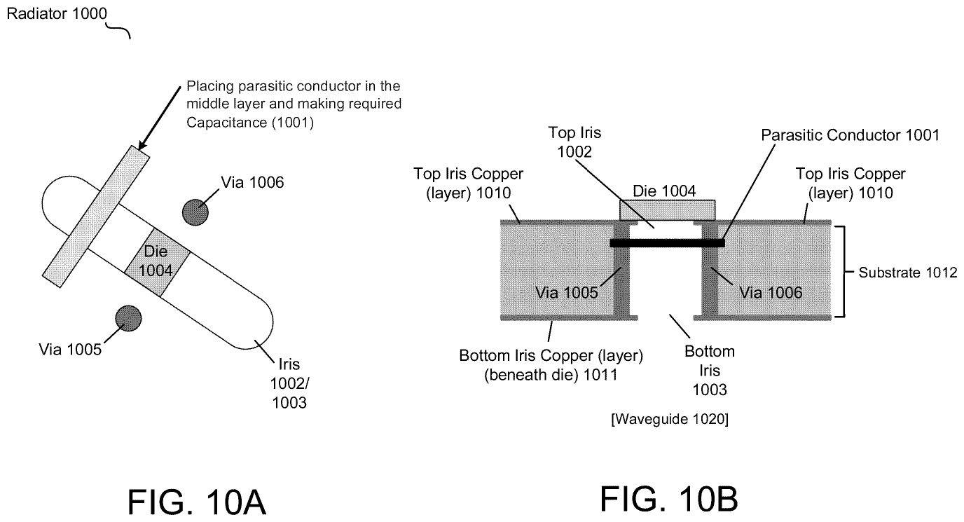

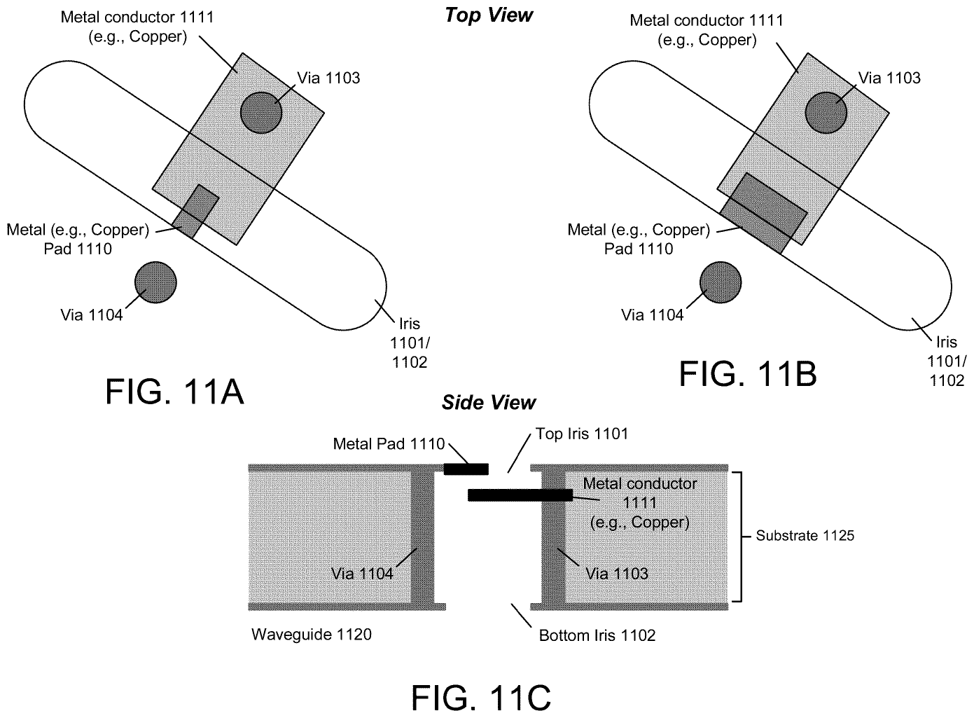

Capitalizing on the diverse layers inherent in PCB technology, this method increases, and potentially maximizes, the potential of middle layers to achieve specific capacitance objectives within the system. This disclosure delves into various techniques tailored for realizing capacitance for distinct purposes through the utilization of the middle layers. FIGS. 10A & 10B illustrate one technique for compensating for capacitance variations arising from fabrication tolerances. By implementing capacitance adjustments within the middle layer, greater control over the conductor patch's size, location, and height from the top layer is attainable. This design enables fine-tuning capacitance with accuracy, mitigating the impact of fabrication discrepancies. FIGS. 11A-11C illustrate an implementation of different required capacitance using the middle layer of the PCB. This design facilitates resonance tuning without the need for a varactor. The resonance can be adjusted by changing the size of the pad a single dimension. With the stability of its features, the copper pad in the middle layer and all other components remain fixed, the only adjustable element is the size of the copper pad on the top layer. An advantage of this design extends beyond its tunable capacitance; it offers enhanced stability and reliability by reducing, and potentially minimizing, movable components, providing a robust solution for various RF applications. By combining RF shielding with tunable capacitance capabilities, this disclosure lays the foundation for cutting-edge electronics engineering, enabling high-performance systems for diverse domains. The integration of the double layer iris and surrounding vias provides robust RF shielding, while the intelligent use of the middle layer enables precise capacitance goals. This technique for controlling resonance can be used with antenna elements that do not include vias on the sides of the slots to reduce mutual coupling.

FIGS. 10A-10B illustrate some embodiments of a double layer iris radiator that includes structures for compensating the capacitance due to tolerance fabrication in which the capacitance is implemented using the middle layer such that the size of the conductor patch (parasitic conductor), location and its height from the top layer can be adjusted.

More specifically, referring to FIG. 10A, the double layer iris radiator 1000 includes a parasitic conductor 1001. Parasitic conductor 1001 is placed in a middle layer in the substrate between the top metal layer forming the top iris (slot) and the bottom metal layer forming the bottom iris (slot). Parasitic conductor 1001 overlaps a portion of vertically-stacked iris (slot) 1002 and iris (slot) 1003. Note that the location of the overlap of parasitic conductor 1001 of the vertically-stacked iris (slot) 1002 and iris (slot) 1003 can be anywhere along the vertically-stacked iris (slot) 1002 and iris (slot) 1003. Both the size and location of parasitic conductor 1001 can be selected to control the capacitance. In some embodiments, the larger and closer parasitic conductor 1001 is to the center of slot, the greater the capacitance it will create.

One or more vias, such as vias 1005 and 1006, are located on both elongated sides of vertically-stacked iris (slot) 1002 and iris (slot) 1003 and extend between the metal layers in which vertically-stacked iris (slot) 1002 and iris (slot) 1003 are formed. In some embodiments, die 1004 is coupled across iris (slot) 1002.

FIG. 10B is a side view of the double layer iris radiator. As shown, the parasitic conductor 1001 is in substrate 1012 between top iris metal layer 1010 (e.g., a copper layer, etc.) and bottom iris metal layer 1011 (e.g., a copper layer, etc.) electrically coupled by vias 1005 and 1006. A waveguide 1020 is beneath the double layer iris radiator 1000. Parasitic conductor 1001 can be placed anywhere in the middle layers of substrate 1012 based on the desired capacitance compensation. In other words, moving parasitic conductor 1001 to different locations (depths) within substrate 1012 can change the capacitance that results and thus can be selected to achieve a desired capacitance. In some embodiments, increasing the thickness of parasitic conductor 1001 can increase the capacitance if so desired, while decreasing the thickness of the parasitic conductor 1001 can decrease the capacitance if so desired.

FIG. 11A-11C illustrate some embodiments of a double layer iris radiator implementing different required capacitance using a middle layer of a PCB. This design allows for resonance tuning without the need for a varactor or other tuning element, enabling the die found in double layer iris radiator discussed above to be removed.

Referring to FIGS. 11A-11B, two embodiments of a double layer iris radiator that includes structures to control its resonance are shown. These embodiments present an alternative to using a die with a varactor or other tuning element over the vertically-stacked irises (slots) to control the resonance of a double layer iris radiator. Referring to FIG. 11A, metal (e.g., copper) conductor 1111 is coupled to via 1103 and extends partially over vertically-stacked irises (slots) 1101 and 1102. A metal pad (e.g., copper pad) 1110 is coupled to the iris metal layer in which iris (slot) 1101 and extends from one side of the iris (slot) 1101 to overlap metal conductor 1111. Metal pad 1110 does not electrically connect to via 1104. Referring to FIG. 11B, the double layer iris radiator has a different sized metal pad 1110. In this case, the size of metal pad 1110 is larger than metal pad 1110 in FIG. 11A. By changing the size of metal pad 1110, the resonance associated with the double layer iris radiator can be controlled. In some embodiments, the resonance can be adjusted, or tuned, by changing the width of metal (e.g., copper, etc.) pad 1110 (one dimension along the elongated side of the iris (slot) 1101). This is because changing the size of metal pad 1110 at the top metal layer in which the top iris is formed changes the capacitance. An advantage of this design is that all features are fixed, including the metal conductor (e.g., copper) 1111 in the middle layer. In some embodiments, the only adjustable component is the size of metal pad 1110 on the top iris metal layer, which is easier to modify than the metal conductor 1111 in the middle layers of the substrate (e.g., PCB) 1125. In some embodiments, metal pad 1110 and metal conductor 1111 are size proportionally to each other to obtain a certain resonance for antenna element designs having different either metal pads or metal conductors of different sizes. Note that in some embodiments, the height of the PCB (substrate 1125) is 10-12 mil.

FIG. 11C illustrates a sideview of either the double layer iris radiators in FIGS. 11A and 11B. As shown in FIG. 11C, a waveguide 1120 is beneath the double layer iris radiator in which top iris (slot) 1101 and bottom iris (slot) 1102 are vertically-stacked and metal conductor 1111 is in substrate 1125 and extends into the area in which top iris (slot) 1101 and bottom iris (slot) 1102 are vertically-stacked. Vias 1104 and 1103 extend between the top metal layer in which top iris (slot) 1101 is formed and the bottom metal layer in which bottom iris (slot) 1102 is formed.

### Mutual Coupling Reduction in Metasurface Antennas

Mutual coupling reduction in metasurface antenna with subwavelength elements and spacing is a challenge. The conventional method for mutual coupling reduction is to add resonant structures between radiating elements to suppress the surface waves, which is not feasible where the antenna elements are tightly spaced and there is no more room for such intermediate elements which are not small enough.

Techniques for reducing the mutual coupling between metasurface elements are disclosed herein. These techniques do not have the limitations described above. In a metasurface antenna, as the RF radiating antenna elements (e.g., resonators) are very close to each other, the mutual coupling would be high, resulting in a degradation in directivity and the efficiency of the antenna. This restricts the metasurface design, and thus the size of elements cannot be increased from a certain threshold because the mutual coupling increases, thereby resulting in a degradation in performance. Techniques to decrease the mutual coupling between metasurface RF radiating antenna elements (e.g., resonators) disclosed herein enable significant flexibility in the design of metasurface RF radiating antenna elements (e.g., resonators) as the size restriction is lifted to some extent. As a result, performance of metasurface antenna can be potentially improved.

Innovations are disclosed herein related to the reduction of mutual coupling. For example, the use of waveguide-fed metasurface antenna structures has shown excellent beamforming capabilities by making up for the limited phase range. This can be achieved by closely examining a subset of the slots on an aperture, typically using one-sixth or less of the operating wavelength and taking advantage of the guided wave's phase advancement. However, these closely spaced RF radiating antenna elements (e.g., resonators) have significant detrimental coupling effects on each other that reduce the antenna performance and put restrictions on the size of the elements. Disclosed herein are at least two methods to reduce the mutual coupling between elements. In some embodiments, an electromagnetic bandgap (EBG) is used between RF radiating antenna elements (e.g., resonators) to suppress the surface wave resulting in mutual coupling reduction. In this structure, the EBG geometries are added between metasurface elements within the substrate (e.g., PCB) of the metasurface. In some other embodiments, a component of electromagnetic mode is added to the primary mutual coupling mode so that the superposition of these two would have lower amplitude compared to the primary mode. In some embodiments, the disclosed structure includes two iris layers and connecting vias that connect the top and bottom iris meal layers. One advantage of the disclosed techniques is its simplicity that, unlike other mutual coupling reduction structures proposed in literature, is easy to realize in commercial products. The disclosed structures also provide opportunities in taking advantage of the area between two iris layers for routings or any other purposes.

There are prior art mutual coupling reduction methods, including adding features between radiating elements to suppress the surface wave. However, in metasurface antennas, the elements are spaced densely and tightly, and there is not much space between them. Therefore, those methods cannot be easily realized in metasurface antennas.

As disclosed herein, the mutual coupling reduction methods include one or more of the following features: a simple and low-cost structure, a low-risk method as it does not change existing metasurface structure designs significantly, and, in at least one embodiment, an opportunity to use medium between iris layers (discussed herein below) for different purposes such as routing layers. The use of these features results in lower mutual couplings between elements and a potential increase in directivity and efficiency

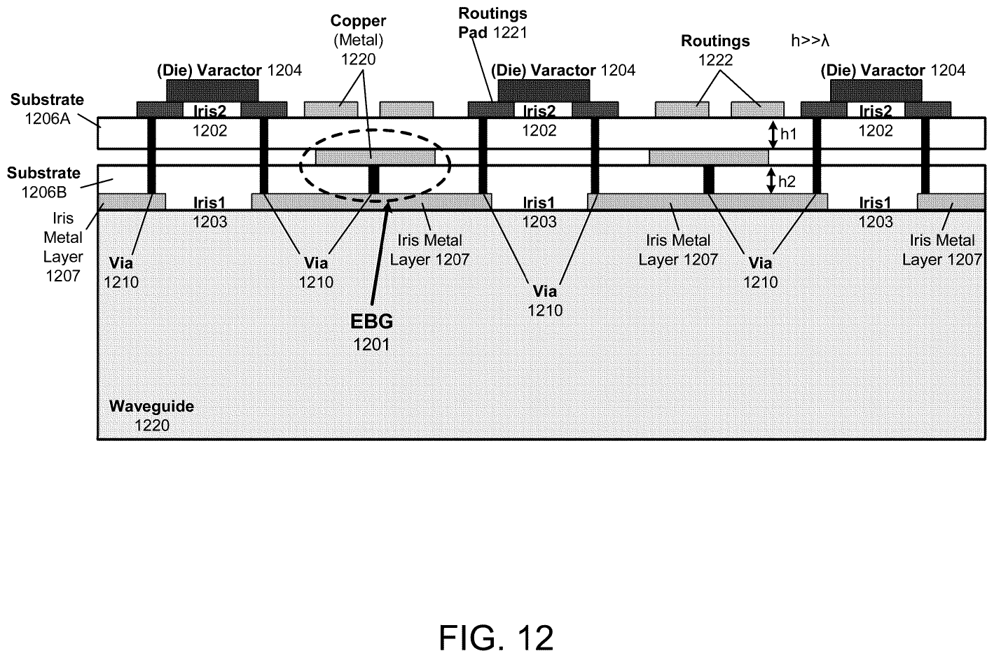

An explanation follows of some embodiments of mechanisms for reducing mutual coupling reduction between RF radiating antenna elements (e.g., resonator) in a metasurface. FIG. 12 illustrates a portion of some embodiments of an antenna aperture that includes a structure between RF radiating antenna elements (e.g., adjacent double layer iris resonators) for mutual coupling reduction. These structures are in a substate (e.g., PCB, etc.) of the aperture.

Referring to FIG. 12, the RF radiating antenna elements are part of a metasurface. In some embodiments, the RF radiating antenna elements include double layer iris resonators that have a double iris with two vertically stacked irises, a varactor (or other tuning element), pads and vias (extending through the substrate and between the metal layers in which the irises are formed). Between each of the RF radiating antenna elements is at least one electromagnetic bandgap (EBG) structure. In some embodiments, the EBG structure is mushroom-shaped with a cap and a stalk. The cap extends between two substrates (e.g., PCBs) in parallel (e.g., vertically) with the top and bottom of the substrates, while the stack is connected to the cap and extends and couples to the lower iris metal layer in which the lower iris is formed (much in the way a via extends through the substrate). While this EBG structure is a mushroom-shaped, the techniques disclosed herein are not limited to that shape and any other EBG shape, with or without one or more vias, can be used. Note that there could be more than one EBG between pairs of RF radiating antenna elements.

Referring to FIG. 12, a side view of an aperture having multiple double layer iris radiators has vertically-stacked irises (slots) 1202 and 1203 with a die 1204 (e.g., varactor or other tuning element and can include a capacitor and/or an amplifier) coupled across iris (slot) 1202 and is coupled to a substrate 1206A (e.g., PCB, etc.) using pads 1221. Vias 1210 are coupled to pads 1221, which are coupled to die 1204, and extend through substrates 1206A and 1206B and couple to iris metal layer 1207 in which iris (slot) 1203 is formed. Iris metal layer 1207 is on top of waveguide 1220. Substrates 1206A and 1206B separate the layers forming irises (slots) 1202 and 1203. Substrates 1206A and 1206B include EBG 1201 to suppress the electromagnetic modes (surface wave) over the surface of the antenna, thereby resulting in a reduction of mutual coupling between elements of the metasurface antenna. As shown, EBG 1201 includes a cap extending within a layer of the substrate (e.g., mushroom cap) with a stalk that couples the cap to the iris metal layer 1207. The surface on top of substrate 1206A can be used for routings and bias lines that feed the varactor. Metal routings 1222 also appear on top of substrates 1206A and 1206B and are formed with metal 1220. In some embodiments, metal 1220 is copper. Copper is also used as the cap of EBG 1201.

The height h₁ of substrate 1206A and the height h₂ of substrate 1206B are shown. In some embodiments, h₁ and h₂ are the same. In some other embodiments, h₁ and h₂ are different. In some embodiments, the height of substrates is very small to reduce, and potentially minimize, the effect of routings and EBG on the performance of the radiating iris. For example, the height of the substrates h₁ and h₂ can be 5 mil, 10 mil, 15 mil, 20 mil, etc. In some embodiments, the height h₁ of the upper substrate 1206A is 10 mil in height (h) while the height h₂ of the lower substrate 1206B is 10-20 mil.

Vias 1210 can include one or more vias on each elongated side (e.g., one on each side, two on each side, three on each side, etc., a different number of vias on each side, etc.) of the iris going up through each of the substrate layers.

The EBGs suppress the electromagnetic modes (surface wave) over the surface of the antenna. This results in a reduction of mutual coupling between elements of the metasurface antenna.

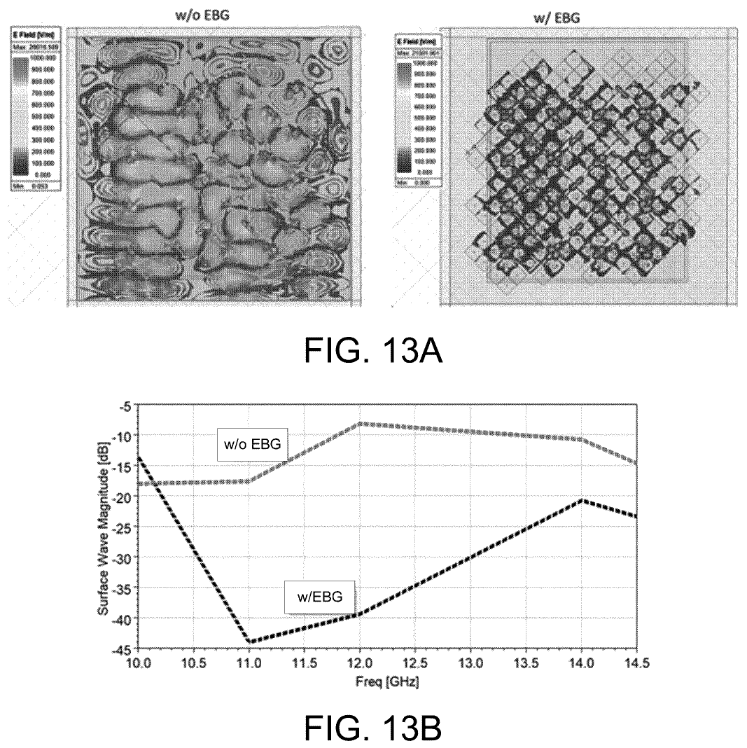

FIGS. 13A and 13B demonstrate how adding EBGs to the metasurface antenna can significantly suppress the surface wave. This can increase the performance of the metasurface antenna. More specifically, FIG. 13A illustrates an electric field distribution over the substrate at center frequency for the metasurface antenna (with rectangular placement) with and without mushroom-shaped EBGs. As shown in FIG. 13A, the surface wave over the substrate has been suppressed in the right figure (with EBG). This will significantly reduce mutual coupling between elements.

FIG. 13B illustrates surface wave magnitude for metasurface antenna shown in FIG. 13A, with and without an EBG. Referring to FIG. 13B, the surface wave is suppressed significantly for the structure with EBG. That is, in FIG. 13B, a graph of the surface wave magnitude versus the frequency shows the width EBG, for a vast majority of the frequencies from 10.2 GHz through 14.5, the surface wave magnitude is far greater than that without the EBG.

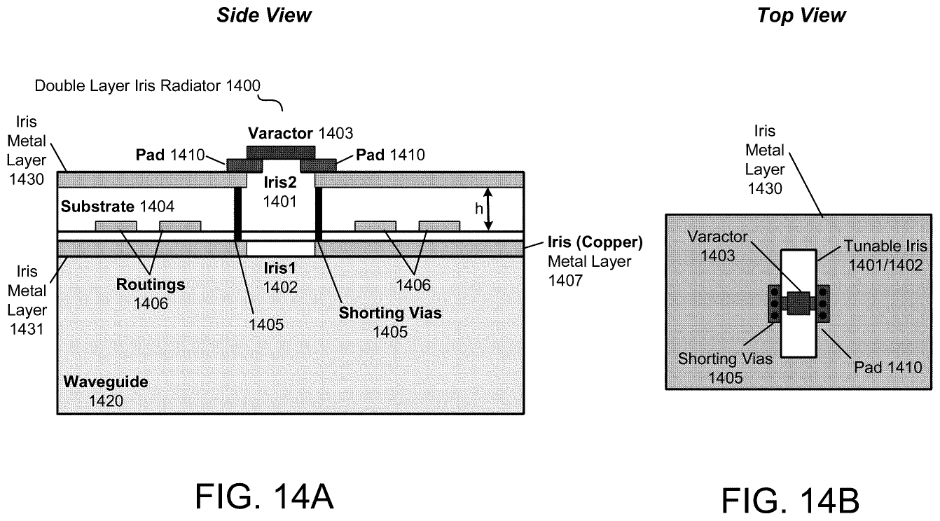

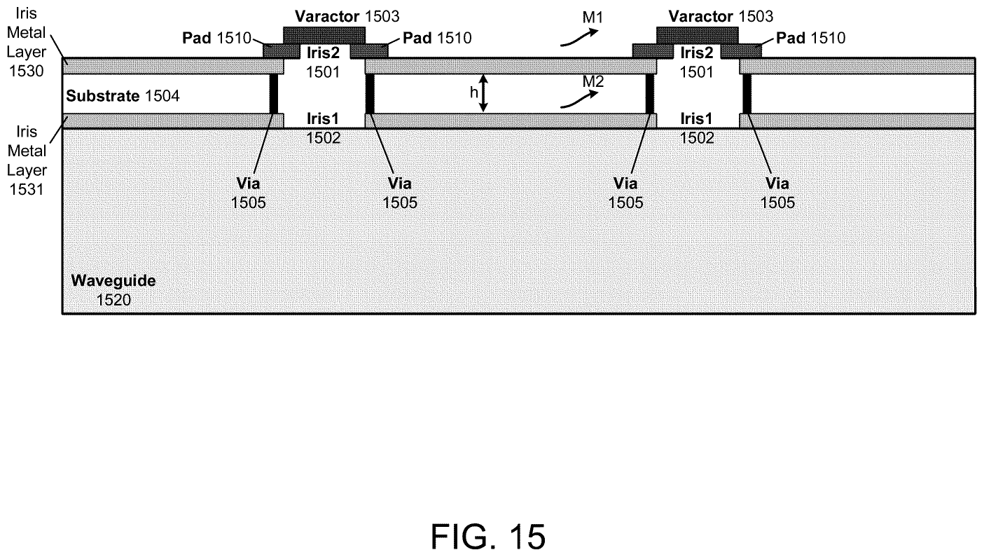

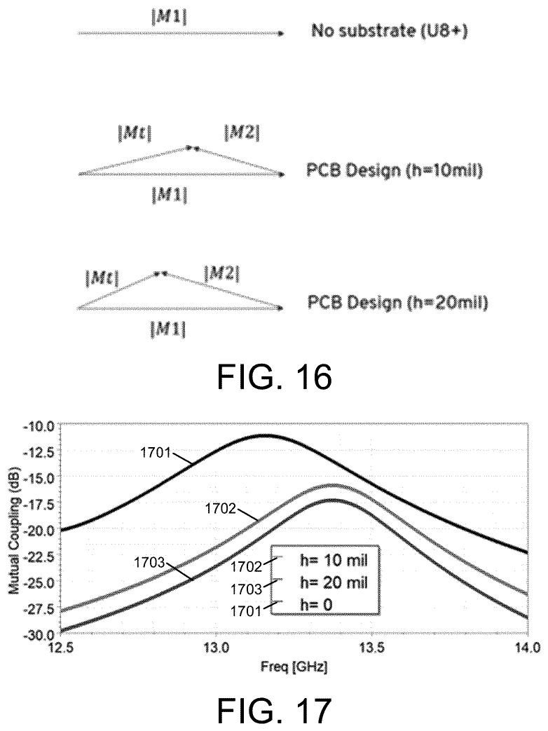

In another coupling reduction technique, two stacked iris layers connected by some vias are used (see FIGS. 14A and 14B). The two irises are coupled together, and the energy can be radiated from the top iris. When the height of the substrate, shown as h in FIGS. 14 and 15, gets to zero, the structure resembles the same structure used previously in metasurfaces. By increasing h (height of the substrate), the parallel plate mode between the two waveguides will increase. In some embodiments, a height to use can be obtained through an optimization process. When the height is increased, the magnitude of vector |M2| gets bigger. In some embodiments, there is a certain size, where the sum of |M2| and |M1| in FIG. 16 gets minimized. That size (and corresponding height) is the height where mutual coupling is minimized. This changes the mutual coupling between the adjacent RF radiating (e.g., resonator) elements. In fact, instead of adding additional structures between metasurface elements to suppress the electromagnetic waves traveling toward one element from the adjacent element as a common method in literature, the mutual coupling (in this technique) is reduced by exploiting two different modes excited in the disclosed double layer iris structure. The superposition of these two modes (which are not in phase) results in a wave that is lower in amplitude compared to the structure with only one mode (TM mode) when h is zero. This may be seen in FIGS. 16 and 17.

FIGS. 14A & 14B illustrate top and side views of some embodiments of an iris-based RF radiating antenna element in the metasurface structure. The disclosed structure includes two iris layers, a substrate, shorting vias, and a varactor. Referring to FIGS. 14A and 14B, the double layer iris radiator 1400 includes iris metal layer 1430 on top of substrate 1404 and forms iris (slot) 1401. On the bottom of substrate 1404 is iris metal layer 1431 that forms iris (slot) 1402. Irises 1401 and 1402 are vertically-stacked and form a tunable iris. Substrate 1404 includes routings 1406. One or more vias 1405 extend between iris metal layer 1430 and 1431. Iris metal layer 1431 sits on top of waveguide 1420. A varactor (or other tuning element) 1403 is coupled via pads 1410 to iris metal layer 1430 and overlays vertically-stacked irises 1401 and 1402. In FIG. 14B, the top view of double layer iris radiator 1400 shows vias 1405 on both sides of a tunable irises of vertically stacked iris (slots) 1401 and 1402 with varactor 1403 extending over irises (slots) 1401 and 1402. Varactor 1403 is coupled via pads 1410 to iris metal layer 1430.

In this configuration, the radiation can be modulated (tuned) by varactor 1403. The shorting vias (or connecting vias) 1405 connect the top and bottom iris metal layers 1430 and 1431 to each other. This couples the power from waveguide 1420 to the top layer for radiation (at iris 1401). In some embodiments, there are at least two shorting vias 1405 (one each side of iris) to provide good coupling between top and bottom iris metal layers 1430 and 1431 and set the correct modulation. The number of vias also change the coupling and resonant frequencies a little (e.g., in some embodiments, less than 5%). Moreover, it changes the level of surface wave excitation within the substrate between top and bottom iris metal layers 1430 and 1431. The vias 1405 can include one or more on each side (e.g., one on each side, two on each side, three on each side, etc., a different number of vias on each side, etc.) of the iris going up through each of the substrate layers. Note that in FIGS. 14A and 14B, the middle layers can be used for routing lines 1406 and bias lines that feed varactor 1403. Then, those routing lines 1406 and bias lines connected to varactor 1403 would use some other vias.

FIG. 15 illustrates two adjacent radiating antenna elements (e.g., resonators). Referring to FIG. 15, iris metal layer 1530 forms iris (slot) 1501 and is on top of substrate 1504. On the bottom of substrate 1504 is iris metal layer 1531 which forms iris (slot) 1502. Vias 1505 extend between iris metal layers 1530 and 1531. The distance between iris metal layer 1530 and iris metal layer 1531 is represented by the distance h in FIG. 15. In some embodiments, via 1505 represents 1 via on each side of the vertically-stacked irises formed by irises 1501 and 1502. In some other embodiments, vias 1505 comprises 2 or more vias that extend on each side of the vertically-stacked irises formed by irises 1501 and 1502. Iris metal layer 1531 sits on top of waveguide 1520. A varactor 1503 is coupled across the vertically-stacked irises 1501 and 1502 and is coupled to iris metal layer 1530 via pads 1510.

The mutual coupling level from the metasurface antenna element (double layer iris radiator) on the left in FIG. 15 to the metasurface antenna element (double layer iris radiator) on the right is determined by two different electromagnetic mode components: one from top of the structure (M1) which is a Transverse-magnetic (TM) mode, and one from the substrate between top and bottom iris layers, which is parallel-plate waveguide mode (M2). In some embodiments, the TM mode (M1) is determined from the spacing between elements for which change is to be avoided. In some embodiments, the spacing is dictated (to mutual coupling) because the spacing between elements cannot be increased (to reduce mutual coupling) due to the grating lobe generation. Therefore, the M1 vector in FIG. 16 is fixed. However, the other mode M2 created in FIG. 16 has its phase and mostly magnitude controlled by the height of this parallel plate waveguide (height of substrate). This second vector can be chosen in a way that the superposition vector Mt (that is proportional to mutual coupling) gets reduced, and potentially minimized. The superposition of these two modes (that are excited by metasurface element at left) at the metasurface element at right makes the level of mutual coupling between these two metasurface elements. Note that M1 and M2 are both vectors (as they both have a magnitude and phase).

FIG. 16 shows different mutual coupling levels for different scenarios for the antenna elements in FIG. 15. Referring to FIG. 16, the top picture shows the mutual coupling wave between two adjacent irises when the thickness of the substrate (h) in FIG. 15 is zero. This means there is only one iris layer. In this picture, only TM mode on top of the structure exists and that is proportional to the mutual coupling wave component. The middle and bottom pictures in FIG. 16 show some embodiments of the structure in FIG. 15 when h=10 mil and 20 mil, respectively. As indicated schematically, the magnitude of the TM mode (|M1|) stays the same as that of top picture for these two cases, but there is a parallel-plate waveguide mode component (|M2|). As the thickness of the substrate increases, the amplitude of this mode will increase. If the phase of |M2| is such that the amplitude level of |Mt| between the adjacent elements is smaller (than other metasurface designs), then the mutual coupling between elements has been successfully reduced. To ensure this occurs, this can be optimized when a small model of Tx and Rx elements is created and the mutual coupling is minimized in a simulation model.

FIG. 17 illustrates multiple plots of the mutual coupling amplitude between adjacent element for metasurface antenna in FIG. 15. Referring to FIG. 17, graph 1701 represents the mutual coupling versus frequency for a height equal to zero. Graph 1702 illustrates the mutual coupling versus frequency where the height equals 10 mil. Graph 1703 represents the neutral coupling versus frequency for when the height equals 20 mil. Thus, as the distance h gets larger, the mutual coupling between adjacent antenna elements is reduced. That is, by increasing the height of the substrate, the mutual coupling between radiating antenna elements (e.g., resonators) reduces. While a further decrease in mutual coupling between elements can be obtained by further increasing h, this would reduce the energy coupling from the waveguide to the top iris. Therefore, in some embodiments, the selection of h is not larger than 20 mil.

While only two adjacent elements are shown in FIGS. 15-17 for simplicity, the concept can be expanded for several metasurface elements that are close to each other. For example, if N elements have coupling effects on each other, in this general case, the effect of coupling on element 1 from other elements (2, 3, . . . , N) can be calculated. Each element would create two vectors like FIG. 16. The superposition of all those vectors (2N-2 vectors in aggregate) will create the mutual coupling of all elements on element 1. Similarly, the disclosed techniques can be used to decrease the mutual coupling for all elements.

As discussed, by reducing the mutual coupling between adjacent elements using the methods introduced here, the performance of the metasurface antenna can be enhanced. One or more embodiments described herein have one or more of the following advantages: higher performance of the antenna, simple structure, a low-risk method as it does not change our metasurface structure significantly, and a low-cost structure.

Thus, techniques for mutual coupling reduction (which is very destructive) in metasurface antennas with subwavelength dimensions have been disclosed. This reduction in mutual coupling can enhance the performance of the metasurface as it can increase the aperture efficiency and radiation efficiency of the structure. In some embodiments, the reduction in mutual coupling is achieved through the integration of an Electromagnetic bandgap (EBG) structure into the layers of the metasurface antenna to suppress the surface wave propagation over the surface of the antenna, which reduces the mutual coupling between elements. In some other embodiments, the reduction in mutual coupling is achieved through the use of a parallel-plate waveguide mode that decreases the mutual coupling between adjacent elements.

### Enhancing Radiation Efficiency of Metasurface Antennas Using a Superstrate

Radiation efficiency of metasurface antennas is not as high as desired as the sizes of elements of metasurface antenna are small, which makes each element a poor radiator. In fact, to avoid grating lobes, it is required to closely sample the aperture, typically using elements with spacing around one-sixth or less of the operating wavelength. This enforces elements to be the size of subwavelength, which reduces their radiation resistance resulting in lower radiation resistance of metasurface.

Techniques are disclosed for increasing the radiation efficiency of metasurface elements. In some embodiments, the radiation efficiency is significantly improved by using a superstrate on top of the tunable element and placing the diode on top of the superstrate. This is very important as the radiation efficiency of metasurface antennas is low due to high losses (i.e. conductor loss, dielectric loss, and diode resistance loss), and low radiation resistance of the antenna element. This increases the realized gain of both transmit and receive modes. However, higher radiation efficiency is more vital in receivers as it significantly improves the SNR (signal to noise ratio) of the metasurface. One advantage of the disclosed techniques is its simplicity in that is the only thing needed is to add another layer on top of the metasurface without changing the elements configuration.

It should be noted that the size of the RF radiating antenna elements (e.g., radiators) cannot be increased to improve the radiation efficiency because this increases the mutual coupling between elements that will further reduce the radiation efficiency and aperture efficiency. However, the proposed techniques do not need to change the geometry of the RF radiating antenna elements.

Some embodiments have one or more of the following advantageous features: simple structure, a low-risk method as it does not change our metasurface structure significantly, and a low-cost structure as it only adds a single layer on top. Some embodiments have an increase in radiation efficiency which also implies the potential increase in realized gain.

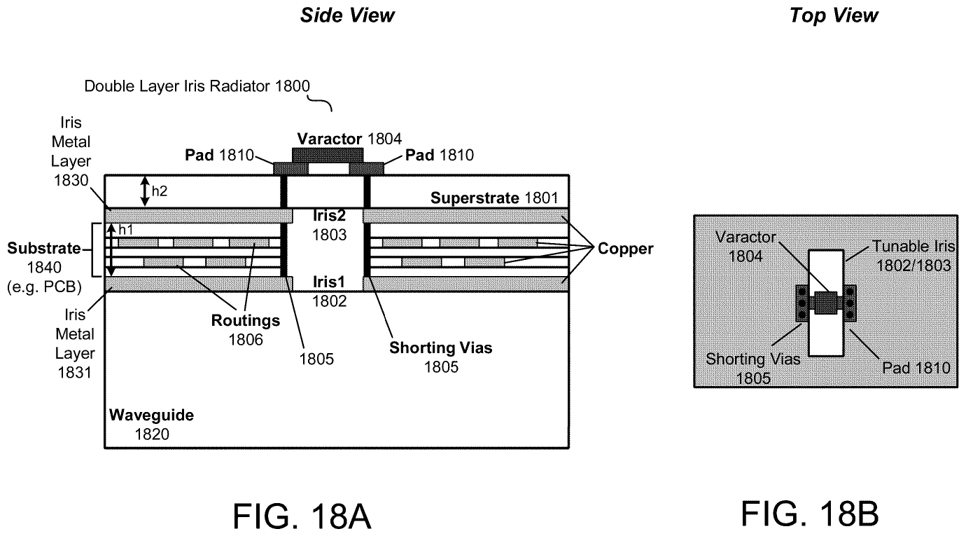

FIGS. 18A and 18B illustrate some embodiments of a metasurface antenna with an integrated superstrate. In some embodiments, the geometry of the metasurface elements includes iris layers, varactor, pads and its vias, and a superstrate. In some embodiments, the varactor is integrated over the superstrate and is connected, by two pads and some vias, to the iris layers. There are two coupled iris layers connected by vias. In some embodiments, there are several layers between the two iris layers, which are used for routings of biasing circuitries to drive the varactors.

Referring to FIGS. 18A and 18B, double layer iris radiator 1800 includes a waveguide 1820 that is below iris metal layer 1831 in which iris (slot) 1802 is formed. A substrate 1840 sits on top of iris metal layer 1831. Substrate 1840 includes routings 1806. In some embodiments, substrate 1840 has a height h₁ of 10-20 mil. Iris metal layer 1830 sits on top of and coupled to substrate 1840 and iris (slot) 1803 is formed in iris metal layer 1830. Irises 1802 and 1803 are vertically-stacked irises.

A superstrate 1801 is on top of and coupled to iris metal layer 1830. In some embodiments, superstrate 1801 has a height h₂ of 10 mil, though it can be other sizes similar to that of substrate 1840. Iris metal layers 1830 and 1831 are coupled using vias 1805 on both sides of the vertically-stacked irises. In some embodiments, iris metal layer 1830, iris metal layer 1831 and routings 1806 are copper or another conductive metal. Coupled across the vertically-stacked irises 1802 and 1803 is varactor 1804 (or other tuning element) that are coupled to iris metal layer 1830 through superstrate 1801 using vias and pads 1810. Superstate 1801 is between pads 1810 and the iris metal layer 1830.

FIG. 18B shows the side view of some embodiments of a metasurface structure for enhancing radiation efficiency of the antenna, where the structure includes at least one iris (e.g., a double iris with two vertically stacked irises), at least two substrate layers, vias, and a varactor. The vias can include one or more on each side (e.g., one on each side, two on each side of the antenna element (e.g., resonator), three on each side of the antenna element (e.g., resonator), etc., a different number of vias on each side of the antenna element (e.g., resonator), etc.) of the iris going up through each of the substrate layers. Referring to FIG. 18B, top view of the double layer iris radiator 1800 is shown with a vertically-stacked tunable iris formed by vertically-stacked irises (slots) 1802 and 1803 with varactor 1804 coupled across the tunable iris consisting of irises 1802 and 1803 via pads 1810. Vias 1805 are shown on both sides of tunable iris consisting of irises 1802 and 1803. As shown, vias 1805 include 3 vias on each side of the tunable iris 1802/1803. In some other embodiments, the number of vias on each side of irises 1802 and 1803 includes 1, 2, or more than 3.

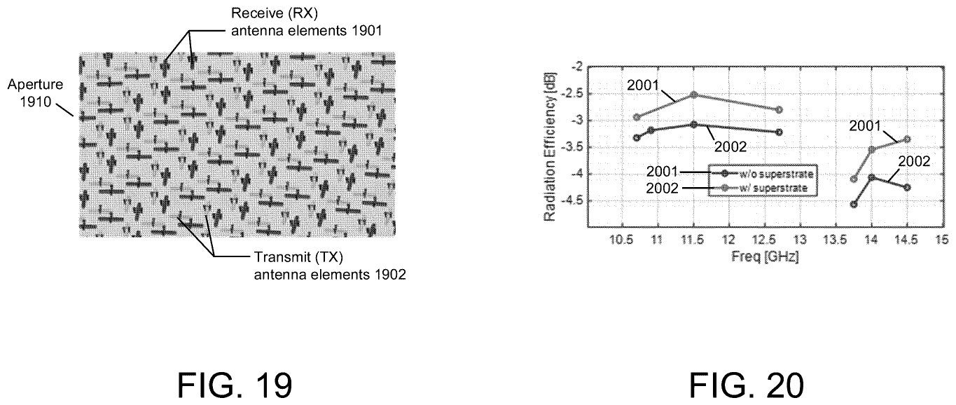

FIG. 19 illustrates receive (Rx) and transmit (Tx) elements of the metasurface antenna with superstrate. Referring to FIG. 19, receive (RX) antenna elements 1901 are shown as darker antenna elements in the partial aperture 1910. Transmit (TX) antenna elements 1902 are shown as lighter antenna elements. FIG. 20 illustrates the radiation efficiency of the metasurface antenna with and without superstrate.

FIG. 20 shows that the radiation efficiency of some embodiments of an antenna with superstrate is far better than the antenna without superstrate over both Rx band (10.7-12.7 GHz) and Tx band (13.75-14.5 GHz). Referring to FIG. 20, a graph of the radiation efficiency versus frequency shows the superstrate represented with graphs 2001 has better radiation efficiency than if the double layer iris radiator did not have the superstrate as shown in graphs 2002. For each case, the structure is improved, and potentially optimized. As shown, the radiation efficiency of the antenna with superstrate is far better than the antenna without superstrate.

Some embodiments disclosed herein include one or more of the following advantages: higher radiation efficiency, a low-risk method as it does not change the metasurface structure significantly, and a low-cost and simple structure

Thus, as disclosed herein, techniques are disclosed for radiation efficiency improvement of metasurface antennas. Some embodiments integrate a superstrate on top of the surface of the antenna to significantly improve the radiation efficiency as it manipulates the loss in the varactor and the radiation resistance of the elements. This innovation is very critical in receive side operation as it significantly improves signal to noise ratio (SNR), which is the most important figure of merit in Rx band.

In some embodiments of the structure described herein, the varactor (while integrated on top of the structure) tunes the top iris and creates the specific modulation for each element. For each element, the two irises are connected (together) by some vias for coupling the electromagnetic waves from the waveguide with high performance. This energy is radiated in Tx from the top iris, and vice versa, the energy is absorbed by the top iris in Rx mode and is coupled to the waveguide through the bottom iris. By including the superstrate, the ratio between the radiation resistance and the entire resistance seen from antenna port (radiation resistance+conductor and dielectric resistance and diode resistance) can be manipulated so that the radiation efficiency can be increased.

There is a number of example embodiments described herein.

Example 1 is an antenna that includes a metasurface having a plurality of RF radiating antenna elements, where each of the plurality of RF antenna elements comprises a double layer iris with a first metal layer having a first iris and a second metal layer having a second iris in which first and second irises form a vertical stack in which the first iris is over the second iris.

Example 2 is the antenna of example 1 that may optionally include at least one via on each of opposite sides of the first iris and second iris extending between and coupling the first and second metal layers.

Example 3 is the antenna of example 2 that may optionally include that the at least one via on each of opposite sides of the first iris is to reduce leakage of electromagnetic energy between RF radiating antenna elements.

Example 4 is the antenna of example 2 that may optionally include that the at least one via comprises a plurality of vias located along a portion of each of two elongated sides of the first and second irises.

Example 5 is the antenna of example 4 that may optionally include that the plurality of vias form a via wall.

Example 6 is the antenna of example 1 that may optionally include a substrate between the first and second metal layers.

Example 7 is the antenna of example 6 that may optionally include that the substrate comprises a printed circuit board (PCB).

Example 8 is the antenna of example 6 that may optionally include that the substrate includes one or more parasitic conductors for each RF radiating antenna element.

Example 9 is the antenna of example 8 that may optionally include that at least one of the one or more parasitic conductors is in a middle layer of the substrate and extends across elongated portion of the first and second irises.

Example 10 is the antenna of example 9 that may optionally include that placement of the one or more parasitic conductors is based on desired capacitance compensation.

Example 11 is the antenna of example 6 that may optionally include a first conductor coupled to the substrate and extending into an open area where the first and second irises overlap; and a second conductor coupled to the first metal layer, the second conductor extending into the first iris and overhanging the first conductor.

Example 12 is the antenna of example 11 that may optionally include that the size of the second conductor is sized with respect to the first conductor to control capacitance for resonance tuning of said each of the plurality RF antenna elements.

Example 13 is the antenna of example 1 that may optionally include a die coupled to the first iris.

Example 14 is the antenna of example 13 that may optionally include that the die comprises a tuning element.

Example 15 is the antenna of example 13 that may optionally include that the die comprises one or more of a capacitor and an amplifier.

Example 16 is the antenna of example 1 that may optionally include a plurality of electromagnetic bandgap (EBG) structures, with a least one of the plurality of EBG structures being located between each pair of RF radiating antenna elements of the plurality of RF radiating antenna elements.

Example 17 is the antenna of example 16 that may optionally include that the at least one EBG structure operates to reduce mutual coupling between RF radiating antenna elements in said each pair.

Example 18 is the antenna of example 17 that may optionally include that the least one EBG structure operates to reduce mutual coupling by suppressing a wave in a substrate between the first and second metal layers of the RF radiating antenna elements in said each pair.

Example 19 is the antenna of example 18 that may optionally include that the at least one of the plurality of EBG structures comprises a mushroom-shaped EBG structure having a conductor as a cap extending through the substrate in parallel with the first and second metal layers and a via though part of the substrate as a stack.

Example 20 is the antenna of example 1 that may optionally include that the first layer has first and second sides, and further comprising: a substrate coupled between a first side of the first metal layer and the second metal layer; a superstrate coupled to the second side of the first metal layer; and a tuning element coupled to the first metal layer and second metal layer.

Example 21 is the antenna of example 20 that may optionally include that the tuning element is coupled to the first metal layer and second metal layer using vias.

Example 22 is an antenna having a metasurface having a plurality of RF radiating antenna elements; and at least one via on each of opposite sides of each RF radiating antenna element of the plurality of RF radiating antenna elements to reduce leakage of electromagnetic energy between adjacent RF radiating antenna elements of plurality of RF radiating antenna elements.

Example 23 is the antenna of example 22 that may optionally include that the at least one via comprises a plurality of vias located along a middle portion of each of two elongated sides of an iris of said each RF radiating antenna element.

Example 24 is the antenna of example 23 that may optionally include that the plurality of vias form a via wall.

Example 25 is the antenna of example 23 that may optionally include that the at least one via comprises three via on each of opposite sides of said each RF radiating antenna element.

Example 26 is the antenna of example 25 that may optionally include that the plurality of vias form a via wall.

Example 27 is the antenna of example 22 that may optionally include that said each RF radiating antenna element comprises a pair of vertically stacked irises formed by two metal layers, and the at least one via is located along a middle of each of two elongated sides of each of the two iris of said each RF radiating antenna element and extend between and couple the two metal layers.

Example 28 is an antenna having: a metasurface having a plurality of RF radiating antenna elements; and a plurality of electromagnetic bandgap (EBG) structures, with a least one of the plurality of EBG structures being located between each pair of RF radiating antenna elements of the plurality of RF radiating antenna elements.

Example 29 is the antenna of example 28 that may optionally include that said at least one EBG structure operates to reduce mutual coupling between RF radiating antenna elements in said each pair.

Example 30 is the antenna of example 28 that may optionally include that the plurality of RF radiating antenna elements comprise a resonator.

Example 31 is the antenna of example 28 that may optionally include that the plurality of RF radiating antenna elements comprise a double iris antenna element with two vertically stacked irises.

Example 32 is the antenna of example 31 that may optionally include that the two vertically stacked irises have a substrate between the two irises and said at least one EBG structure operates to reduce mutual coupling by suppressing a wave in the substrate between the RF radiating antenna elements in said each pair.

Example 33 is the antenna of example 32 that may optionally include that the substrate comprises a PCB.

Example 34 is an antenna having a metasurface structure having a plurality of RF radiating antenna elements. Each of the RF antenna elements includes at least one tunable iris formed in a first metal layer, at least one substrate layer coupled a first side of the first metal layer, a superstrate coupled to a second side of the first metal layer, and a tuning element coupled to the first metal layer through the superstrate.

Example 35 is the antenna of example 34 that may optionally include that the at least one tunable iris is part of a double layer iris with the first metal layer having a first iris and a second metal layer having a second iris in which first and second irises form a vertical stack in which the first iris is over the second iris.

Example 36 is the antenna of example 34 that may optionally include that the tuning element is coupled to the first metal layer and second metal layer using vias.

Example 37 is the antenna of example 34 that may optionally include that the at least one tunable iris comprises a resonator.

Example 38 is the antenna of example 34 that may optionally include that the tuning element comprises a varactor.

Methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. An antenna comprising:
a metasurface having a plurality of RF radiating antenna elements, where each of the plurality of RF antenna elements comprises a double layer iris with a first metal layer having a first iris and a second metal layer having a second iris in which first and second irises form a vertical stack in which the first iris is over the second iris.

2. The antenna of claim 1 further comprising at least one via on each of opposite sides of the first iris and second iris extending between and coupling the first and second metal layers.

3. The antenna of claim 2 wherein the at least one via on each of opposite sides of the first iris is to reduce leakage of electromagnetic energy between RF radiating antenna elements.

4. The antenna of claim 2 wherein the at least one via comprises a plurality of vias located along a portion of each of two elongated sides of the first and second irises.

5. The antenna of claim 4 wherein the plurality of vias form a via wall.

6. The antenna of claim 1 further comprising a substrate between the first and second metal layers.

7. The antenna of claim 6 wherein the substrate comprises a printed circuit board (PCB).

8. The antenna of claim 6 wherein the substrate includes one or more parasitic conductors for each RF radiating antenna element.

9. The antenna of claim 8 wherein at least one of the one or more parasitic conductors is in a middle layer of the substrate and extends across elongated portion of the first and second irises.

10. The antenna of claim 9 wherein placement of the one or more parasitic conductors is based on desired capacitance compensation.

11. The antenna of claim 6 further comprising:
a first conductor coupled to the substrate and extending into an open area where the first and second irises overlap; and
a second conductor coupled to the first metal layer, the second conductor extending into the first iris and overhanging the first conductor.

12. The antenna of claim 11 wherein the size of the second conductor is sized with respect to the first conductor to control capacitance for resonance tuning of said each of the plurality RF antenna elements.

13. The antenna of claim 1 further comprising a die coupled to the first iris.

14. The antenna of claim 13 wherein the die comprises a tuning element.

15. The antenna of claim 13 wherein the die comprises one or more of a capacitor and an amplifier.

16. An antenna comprising:
a metasurface having a plurality of RF radiating antenna elements; and
at least one via on each of opposite sides of each RF radiating antenna element of the plurality of RF radiating antenna elements to reduce leakage of electromagnetic energy between adjacent RF radiating antenna elements of plurality of RF radiating antenna elements.

17. The antenna of claim 16 wherein the at least one via comprises a plurality of vias located along a middle portion of each of two elongated sides of an iris of said each RF radiating antenna element.

18. The antenna of claim 16 wherein the plurality of vias form a via wall.

19. The antenna of claim 16 wherein the at least one via comprises three via on each of opposite sides of said each RF radiating antenna element.

20. The antenna of claim 16 wherein said each RF radiating antenna element comprises a pair of vertically stacked irises formed by two metal layers, and the at least one via is located along a middle of each of two elongated sides of each of the two iris of said each RF radiating antenna element and extend between and couple the two metal layers.
